(19) United States
(12) Patent Application Publication
(10) Pub. No.: US 2003/0225719 A1
(43) Pub. Date: Dec. 4, 2003

(54) Methods and apparatus for fast and robust model training for object classification

(75) Inventors: Biing-Hwang Juang, Warren, NJ (US); Qi P. Li, New Providence, NJ (US)

Correspondence Address: PRIEST & GOLDSTEIN PLLC, 5015 SOUTHPARK DRIVE, SUITE 230, DURHAM, NC, 27713-7736, US

(73) Assignee: Lucent Technologies, Inc., Murray Hill, NJ

(21) Appl. No.: 10/160,934

(22) Filed: May 31, 2002

(51) Int. Cl. G06N 5/02

(52) U.S. Cl. 706/48

(57) ABSTRACT

Techniques for fast and robust data object classifier training are described. A process of classifier training creates a set of Gaussian mixture models, one model for each class to which data objects are to be assigned. Initial estimates of model parameters are made using training data. The model parameters are then optimized to maximize an aggregate a posteriori probability that data objects in the set of training data will be correctly classified. Optimization of parameters for each model is performed through the process of a number of iterations in which the closed form solutions are computed for the model parameters of each model, the model performance is tested to determine if the newly computed parameters improve the model performance and the model is updated with the newly computed parameters if performance has improved. At each new iteration, the parameters computed in the previous iteration are used as initial estimates.

### FIELD OF THE INVENTION

The present invention relates generally to improved aspects of object classification. More particularly, the invention relates to advantageous techniques for training a classification model.

### BACKGROUND OF THE INVENTION

Classification of data objects, that is, the assignment of data objects into categories, is central to many applications, for example vision, face identification, speech recognition, economic analysis and many other applications. Classification of data objects helps make it possible to perceive any structure or pattern presented by the objects. Classification of a data object comprises making a set of observations about the object and then evaluating the set of observations to identify the data object as belonging to a particular class. In automated classification systems, the observations are preferably provided to a classifier as representations of significant features or characteristics of the object, useful for identifying the object as a member of a particular class. An example of a classification process is the examination of a set of facial features and the decision that the set of facial features is characteristic of a particular face. Features making up the set of observations may include ear length, nose width, forehead height, chin width, ratio of ear length to nose width, or other observations characterizing key features of the face. Other classification processes may be the decision that a verbal utterance is made by a particular speaker, that a sound pattern is an utterance of a particular vowel or consonant, or any of many other processes useful for arranging data in order to discern patterns or otherwise make use of the data.

In order to mechanize the process of classification, a set of observations characterizing an object may be organized into a vector and the vector may be processed in order to associate the vector with a label identifying the class to which the vector belongs. In order to accomplish these steps, an object classifier may suitably be designed and trained. A classifier receives data about the object, for example observation vectors, as inputs and will produce as an output a label assigning the object to a class. A classifier employs a model that will provide a reasonable approximation of the expected data distribution for the objects to be classified. This model is trained using representative data objects similar to the data objects to be classified. The model as originally selected or created typically has estimated parameters defining the processing of objects by the model. Training of the model refines, or optimizes, the parameters.

General methodology for optimizing the model parameters frequently falls into one of two categories. These categories are distribution estimation and discriminative training. Distribution estimation is based on Bayes's decision theory, which suggests estimation of data distribution as the first and most important step in the design of a classifier. Discriminative training methods assign a cost function to errors in the performance of a classifier, and optimize the classifier parameters so that the cost is minimized. Each of these methods involves the use of the training data to evaluate the performance of a model over a series of iterations. Prior art distribution estimation techniques tend to require relatively few iterations and are therefore relatively fast, but are more subject to error than are discriminative training techniques. Noise or random variations in data tend to confuse or cause errors in classification using distribution estimation techniques. Prior art discriminative training methods are more resistant to errors and confusion than are distribution estimation techniques, but typically take an open form solution. That is, prior art discriminative techniques involve many iterations of evaluating the performance of the classification model in properly classifying training data, with the classifier parameters being adjusted to explore the boundaries of each class. Because such techniques require many iterations, they are relatively slow. If a large amount of training data is to be processed, discriminative training methods may be so slow as to be impractical.

There exists, therefore, a need for techniques for classifier training that will provide a robustness greater than that of typical prior art distribution estimation techniques and a speed greater than that of typical prior art discriminative training techniques.

### SUMMARY OF THE INVENTION

A process of classifier training according to one aspect of the present invention comprises the use of training data to optimize parameters for each of a set of Gaussian mixture models used for classifying data objects. A number “M” of models is created, one for each class to which data objects are to be assigned. Each object is characterized by a set of observations having a number “I” of mixture components. Each model computes the probability that a data object belongs to the class with which the model is associated. The objective in optimization of the parameters is the maximization of the aggregate a posteriori probability over a set of training data that a data object belonging in the class associated with a model will be correctly assigned to the class to which it belongs.

The parameters to be adjusted for each model are c, Σ and μ, where c is an I-dimensional vector of mixing parameters, that is, the relative weightings of the mixture components of the models, μ is a set of “I” mean vectors, with each vector μ being the mean vector of each mixture component of each model and Σ is a set of “I” covariance matrices showing the distribution of each set of mixture components about each mean. As a first step in optimizing these parameters, initial values for c_{m,i}, Σ_{m,i} and μ_{m,i} are estimated. c_{m,i}, Σ_{m,i} and μ_{m,i} are the components for c, Σ and μ, for each model m and mixture i. This estimation may suitably be done using maximum likelihood estimation, using techniques that are well known in the art. The use of maximum likelihood estimation has the advantage of providing a relatively fast and accurate initial estimate. However, it is not essential to use maximum likelihood estimation. Any of a number of techniques for making an initial estimate of the parameters may be employed, including random selection of values. The performance of each model is then evaluated and the evaluation results stored. After the initial estimation, a series of iterations is begun. At each iteration, a closed form solution for each parameter of the first model is computed. For each parameter, an equation is used to compute the desired parameter. Each equation is developed based on the need to minimize the aggregate a posteriori probability that a data object will be assigned to the wrong class. Minimization of the probability that a data object will be assigned to the wrong class is equivalent to maximizing the probability that a data object will be assigned to the correct class, and the equations may suitably be developed by maximizing an a posteriori probability “J” that a data object will be assigned to the correct class. Each equation computes the desired parameter in terms of maximizing “J”. The training data is substituted into the appropriate equations, and each equation is solved to yield the desired parameter. After solution of the equations to yield the parameters, the parameters are substituted into the model and the model is tested against the training data to determine if its performance is improved. That is, the model is evaluated to determine whether it yields a higher value for “J” than previously. If the performance of the model is improved, the newly obtained parameters are incorporated into the model. If the performance of the model is not improved, the model is not updated with new parameters. However, the newly computed parameters are used as initial parameters for the next iteration. This procedure of computing new parameters, evaluating the model and deciding whether or not to update the model is performed for a predetermined number of iterations. After completion of the predetermined number of iterations for a model, a similar procedure is followed in sequence for all subsequent models until all models have been subjected to the procedure.

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates a process 100 of data modeling according to an aspect of the present invention;

FIG. 2 illustrates a process of parameter estimation according to an aspect of the present invention;

FIG. 3 illustrates a data modeling and classification system according to an aspect of the present invention;

FIG. 4 is a speaker identification system according to an aspect of the present invention; and

FIG. 5 illustrates experimental results produced using techniques of the present invention.

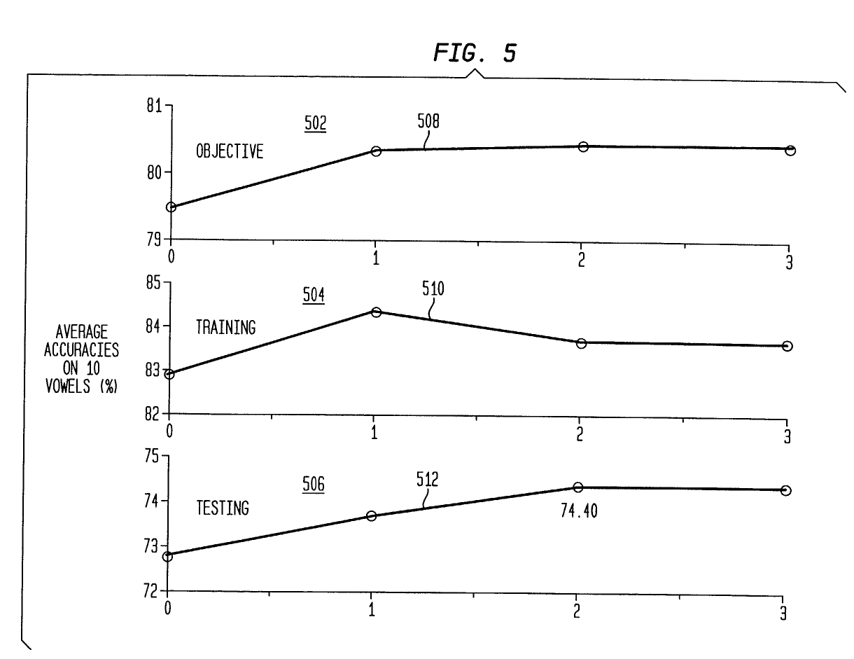

### DETAILED DESCRIPTION

The description which follows begins with an overview and the definition of mathematical terms and concepts as background for the discussion of various presently embodied aspects of the invention which follows.

A process for data classification according to an aspect of the present invention adjusts parameters of a Gaussian mixture model (GMM) in order to minimize the probability of error in classifying a set of training data. In an M-class classification problem, a decision must be made as to whether or not a set of observations about a data object, represented as a vector x, is a member of a particular class, for example Cᵢ. The true class to which x, belongs, for example Cⱼ, is not known, except in the design or training phase in which observation vectors whose class is known are used as a reference for parameter optimization.

Each set of observations used for training comprises a set of data and is labeled to indicate the class to which the set of observations belongs. The action of identifying a set of observations as a member of class “i” may be designated as the event αᵢ. The identification is correct if the set of observations is a member of the class “i” and incorrect otherwise. In order to establish parameters for minimizing the error rate, a zero-one loss function may suitably be used. A suitable equation for a zero-one loss function is equation (1) below:

Ψ(αᵢ|Cⱼ)=0 if i=j, and 1 if i ≠j (1)

where i,j=1, . . . , M.

A loss having a value of “0” is assigned to a correct decision and a unit loss, that is, a loss having a value of “1” is assigned to an error. The probabilistic risk associated with αᵢ is given by equation (2):

$$R ( {α}_{i} \vert x ) = {\sum }_{j = 1}^{M} Ψ ( {α}_{i} \vert {C}_{j} ) P ( {C}_{j} \vert x ) = 1 - P ( {C}_{i} \vert x ) , \qquad ( 2 )$$

where P(Cᵢ|x) is the a posteriori probability that x belongs to Cᵢ. To minimize the probability of error, it is desired to maximize the a posteriori probability P(Cᵢ|x). This is the basis of Bayes' maximum a posteriori (MAP) decision theory and is also referred to as the minimum error rate (MER) or minimum classification error (MCE) criterion. The a posteriori probability P(Cᵢ|x) is often modeled as P_{λ}_{ᵢ}(Cᵢ|x), a function defined by a set of parameters λᵢ. The parameter set λᵢ has a one to one correspondence with Cᵢ, and therefore the expression P_{λ}_{ᵢ}(Cᵢ|x)=P(λᵢ|x) and other similar expressions can be written without ambiguity. An aggregate a posteriori probability (AAP) “J” for the set of design samples {x_{m,n}; n=1,2, . . . , Nₘ, m=1,2, . . . , M} is given in equation (3):

$$J = \frac{1}{M} {\sum }_{m = 1}^{M} \{ {\sum }_{n = 1}^{{N}_{m}} p ( {λ}_{m} \vert {x}_{m , n} ) \} = \frac{1}{M} {\sum }_{m = 1}^{M} \{ {\sum }_{n = 1}^{{N}_{m}} \frac{p ( {x}_{m , n} \vert {λ}_{m} ) {P}_{m}}{p ( {x}_{m , n} )} \} , \qquad ( 3 )$$

where x_{m,n} is the n'th training token, or observation in the set of observations x, from class m, Nₘ is the total number of tokens from class m, M is the total number of classes and Pₘ is the corresponding prior probability. The bracketed expression is the aggregate a posteriori problem.

This problem can be solved by writing J as follows:

$$\begin{matrix}max J = max \frac{1}{M} {\sum }_{m = 1}^{M} {\sum }_{n = 1}^{{N}_{m}} l ( {d}_{m , n} ) = max \frac{1}{M} {\sum }_{m = 1}^{M} {\sum }_{n = 1}^{{N}_{m}} {l}_{m , n} , where \\ l ( . ) = \frac{1}{1 + {ⅇ}^{- {d}_{m , n}}} is a sigmoid function and & ( 4 ) \\ {d}_{m , n} = log p ( {x}_{m , n} \vert {λ}_{m} ) {P}_{m} - L ( log {\sum }_{j \neq m} p ( {x}_{m , n} \vert {λ}_{j} ) {P}_{j} ) . & ( 5 )\end{matrix}$$

Equation 5 above contains a weighting scalar 1≧L>0 to regulate the numeric significance of the a posteriori probability of the competing classes. When L=1, the value of “J” in equation (4) above is equivalent to that in equation (3) and the objective of maximizing “J” is equivalent to the empirical cost function for MCE discriminative training. The empirical cost function for MCE discriminative training is known in the art.

Classifier training according to the present invention has as its objective the maximization of “J,” that is, the aggregate a posteriori probability for a set of training data. A Gaussian mixture model (GMM) is implemented in order to achieve classification, and the parameters of the GMM are adjusted through a series of iterations in order to maximize the value of “J” for the set of training data.

A GMM is established for each class, with each GMM being adapted to the number of mixture components characterizing the training data. The basic form of the GMM for a class m is given in equation 6:

$$p ( {x}_{m , n} \vert {λ}_{m} ) = {\sum }_{i = 1}^{1} {c}_{m , i} * p ( {x}_{m , n} \vert {λ}_{m , i} ) = {\sum }_{i = 1}^{I} {c}_{m , i} ( \frac{1}{{( 2 π )}^{d / 2} * {\vert {\sum }_{m , i} \vert}^{1 / 2}} * ( - \frac{1}{2} * exp [ {( {x}_{m , n} - {μ}_{m , i} )}^{T} {\sum }_{m , i}^{- 1} ( {x}_{m , n} - {μ}_{m , i} ) ] ) , \qquad ( 6 )$$

where T is the matrix transpose, the summation

$${\sum }_{i}^{I} {c}_{m , i} = 1 , {λ}_{m , j} ⋐ {λ}_{m}$$

defines the mixture kernel p(x_{m,n}|λ_{m,i}) and I is the number of mixture components that constitute the conditional probability density.

If “M” classes exist in a classification problem, there should be “M” GMM equations, one for each value of m from 1 to “M.” In order to perform classification for a data object whose class is unknown, the vector comprising the data object is used as an input in each (GMM equation to yield a probability that the data object belongs to the class described by the equation. The observation is assigned to the class whose GMM equation yields the highest probability result.

Training a GMM comprises using the training data to optimize the parameters c, Σ and μ for each GMM in order to give the GMM the best performance in correctly identifying the training data. In order to accomplish this result, the parameters are optimized so that the value of “J,” described above in equation (4), is maximized.

The parameter c is a vector giving the mixing parameter of each mixture component. The mixing parameter for a mixture component indicates the relative importance of the mixing component, that is, the importance of the mixing component with respect to the other mixture components in assigning an object to a particular class. The elements of the vector c can be given by c_{m,i}, where i indicates the mixture component and m indicates the class. The parameter Σ_{m,i} is the covariance matrix for the mixture component i and class m. The parameter μ_{m,i} is the mean vector of the mixture component i and class m.

If ∇_{θ}_{_{m,i}}J is the gradient of J with respect to θ_{m,i}⊂λ_{m,i}, a necessary condition of maximization of J is that ∇_{θ}_{_{m,i}}J=0. This requirement yields the following:

$$\begin{matrix}{∇}_{{θ}_{m , i}} J = {\sum }_{n = 1}^{{N}_{m}} {ω}_{m , i} ( {x}_{m , n} ) {∇}_{{θ}_{m , i}} log p ( {x}_{m , n} \vert {λ}_{m , i} ) - \\ L {\sum }_{j \neq m} {\sum }_{\overline{n} = 1}^{{N}_{m}} {ϖ}_{j , i} ( {x}_{j , \overline{n}} ) {∇}_{{θ}_{m , i}} log p ( {x}_{j , \overline{n}} \vert {λ}_{m , j} ) = 0 , & ( 7 ) \\ {ω}_{m , i} ( {x}_{m , n} ) = {l}_{m , n} ( 1 - {l}_{m , n} ) \frac{{c}_{m , i} p ( {x}_{m , n} \vert {λ}_{m , i} {P}_{m} )}{p ( {x}_{m , n} \vert {λ}_{m , i} {P}_{m} )} , and & ( 8 ) \\ {ϖ}_{j , i} ( {x}_{j , n} ) = {l}_{j , n} ( 1 - {l}_{j , n} ) \frac{{c}_{m , i} p ( {x}_{j , n} \vert {λ}_{m , i} {P}_{m} )}{{\sum }_{k \neq j} p ( {x}_{j , n} \vert {λ}_{k} {P}_{k} )} . & ( 9 )\end{matrix}$$

Finding values for c, Σ and μ involves finding a solution to equation (7) above. In order to simplify the process of solving equation (7), it is assumed that ω and \overline{ω} can be approximated as constants. This assumption produces a typically small error, but even this error can be largely overcome by computing values for c, Σ and μ, testing the values in the GMM, determining whether the values improve the performance of the GMM and then repeating this process through several iterations, with the newly computed values in a previous iteration being used as initial values in the next iteration.

Equation (6) above can be rewritten as follows:

$$log p ( {x}_{m , n} \vert {λ}_{m , i} ) = log p [ {( 2 π )}^{d / 2} {\vert {\sum }_{m , i} \vert}^{1 / 2} ] - \frac{1}{2} {( {x}_{m , n} - {μ}_{m , i} )}^{T} {\sum }_{m , i}^{- l} ( {x}_{m , n} - {μ}_{m , i} ) .$$

In order to optimize Σ_{m,i}, the derivative of the above expression with respect to Σ_{m,i} is taken in equation (10):

$${∇}_{{\sum }_{m , i}} log p ( {x}_{m , n} \vert {λ}_{m , i} ) = - \frac{1}{2} {\sum }_{m , i}^{- l} + \frac{1}{2} {\sum }_{m , i}^{- l} ( {x}_{m , n} - {μ}_{m , i} ) {( {x}_{m , n} - {μ}_{m , i} )}^{T} {\sum }_{m , i}^{- l} \qquad ( 10 )$$

Substituting equation (10) into equation (7) and rearranging the terms yields a solution for Σ_{m,i} as follows:

$${\sum }_{m , i} = \frac{A - LB}{D} , \\ where D = {\sum }_{n = 1}^{{N}_{m}} {ω}_{m , i} ( {x}_{m , n} ) - L {\sum }_{j \neq m} {\sum }_{n = 1}^{{N}_{j}} {ϖ}_{j , i} ( {x}_{j , n} ) , \\ \begin{matrix}A = {\sum }_{n = 1}^{{N}_{m}} {ω}_{m , i} ( {x}_{m , n} ) ( {x}_{m , n} - {μ}_{m , i} ) {( {x}_{m , n} - {μ}_{m , i} )}^{T} , and \\ B = {\sum }_{j \neq m} {\sum }_{\overline{n} = 1}^{{N}_{j}} {ϖ}_{j , i} ( {x}_{j , \overline{n}} ) ( {x}_{j , \overline{n}} - {μ}_{m , i} ) {( {x}_{j , \overline{n}} - {μ}_{m , i} )}^{T} .\end{matrix} \qquad ( 11 )$$

The regulating parameter “L” is used to insure the positive definiteness of Σ_{m,i}. The value of D depends on “L,” so it is necessary to find the value of “L” in order to solve for Σ_{m,i}. If eigenvectors for A⁻¹B exist, it is possible to construct an orthogonal matrix U, such that A−LB=U^{T}(\overline{A}−L\overline{B})U, where both \overline{A} and \overline{B} are diagonal, and both A−LB and \overline{A}−L\overline{B} have the same eigenvalues. “L” can then be determined by equation (13) as:

$$L < min {\{ \frac{{\overline{a}}_{i}}{{\overline{b}}_{i}} \}}_{i = 1}^{d} \qquad ( 13 )$$

where \overline{aᵢ}>0 and \overline{bᵢ}>0 are the diagonal entries of \overline{A} and \overline{B}, respectively. “L” must also satisfy D(L)=>0 and 0<L≦1.

Once “L” has been determined, it is then possible to obtain a value for “D,” and then solve for Σ_{m,i} using equation (11).

The value of μ_{m,i} can be found by taking the derivative of equation (10) above with respect to the vector μ_{m,i}:

$${∇}_{{μ}_{m , i}} log p ( {x}_{m , n} \vert {λ}_{m , i} ) = {\sum }_{m , i}^{- 1} ( {x}_{m , n} - {μ}_{m , i} ) \qquad ( 14 )$$

Substituting equation (14) into equation (7) and rearranging the terms yields a solution for μ_{m,i}:

$${μ}_{m , i} = \frac{1}{D} [ {\sum }_{n = 1}^{{N}_{m}} {ω}_{m , i} ( {x}_{m , n} ) {x}_{m , n} - L {\sum }_{j \neq m} {\sum }_{n = 1}^{{N}_{j}} {\tilde{ω}}_{j , i} ( {x}_{j , n} ) {x}_{j , n} ] \qquad ( 15 )$$

Finally, the mixture parameters c_{m,i} can be computed, subject to the constraint

$${\sum }_{i}^{I} {c}_{m , i} = 1.$$

Introducing the Lagrangian multiplier γ yields:

$$\overline{J} = J + γ ( {\sum }_{i = 1}^{I} {c}_{m , i} - 1 ) + … \qquad ( 16 )$$

Taking the first derivative and vanishing it for minimization yields:

$$\frac{\partial \overline{J}}{\partial {c}_{m , j}} = \frac{1}{{c}_{m , i}} D + γ = 0$$

Rearranging the terms of the above equation yields the solution for c_{m,i} of:

$${c}_{m , i} = - \frac{1}{γ} D \qquad ( 17 )$$

A solution for γ can be obtained by summing over C_{m,i} for i=1. . . I, as shown by equation (18) below:

$$γ = - [ {\sum }_{n = 1}^{{N}_{m}} {\sum }_{i = 1}^{I} {ω}_{m , i} ( {c}_{i} , {x}_{m , n} ) - L {\sum }_{j \neq m} {\sum }_{n = 1}^{{N}_{j}} {\sum }_{i = 1}^{I} {\tilde{ω}}_{j , i} ( {c}_{i} , {x}_{j , \overline{n}} ) ] \qquad ( 18 )$$

The value of γ is then substituted into equation (17) above to produce a solution for cₘᵢ. Closed form solutions for Σₘᵢ, μₘᵢ, and cₘᵢ are thus available for use.

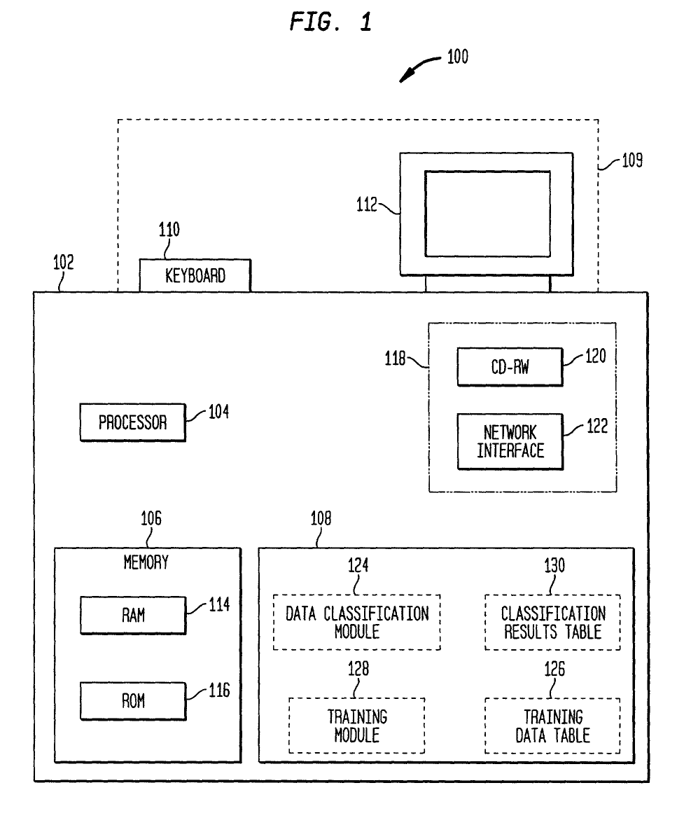

FIG. 1 illustrates a process 100 of data classification according to a presently preferred embodiment of the present invention. For each possible class, a model is created and trained. Once the models are trained, the classifier operates on each data object, or set of observations, submitted to it in order to compute the probability that the data object belongs to the class for which the model has been created. As noted above, a classification process may be the classification of observations of facial features as being associated with a particular face. In this case, each data object to be classified is a set of observations describing facial characteristics. For each class, or facial identification, to which data objects, or sets of facial characteristics, were to be assigned, a Gaussian mixture model would then be created to compute the probability that the set of facial features was characteristic of the facial identification associated with the model. Other classification processes may be the decision that a verbal utterance is made by a particular speaker, that a sound pattern is an utterance of a particular vowel or consonant, or any of a large number of other processes useful for arranging data in order to discern patterns or otherwise make use of the data.

The classifier employs a set of models, one model for each class into which objects are to be placed. Each model operates on the observations comprising data object to classify the data object, and each model is preferably adapted to employ a number of mixture components appropriate for the training data.

FIG. 1 illustrates an exemplary data classification system 100 according to an aspect of the present invention. The system 100 may suitably be implemented as a personal computer (PC), including a processor 104, memory 106, hard disk 108 and user interface 109 including keyboard 110 and monitor 112. The memory 106 may suitably include RAM 114 for short term storage of instructions and data and ROM 116 for relatively long term storage of operating instructions and settings. The classification system 100 also preferably includes a data interface 118 for receiving relatively large volumes of data such as a collection of training data or a set of data objects to be classified, and providing relatively large volumes of data for external use, such as a set of data objects along with classification labels. The data interface may suitably include one or more of a compact disk reader and writer (CD-RW) 120 or a network interface 122.

The computer 102 hosts a data classification module 124, which may suitably be stored on the hard disk 108 and loaded into the RAM 114 when required for execution by the processor 104. The data classification module 124 accepts as inputs one or more data objects where each data object comprises a set of observations. The data classification module 124 assigns each object to one of a plurality of designated classes, suitably by assigning to the object a label indicating the class to which it belongs. The data classification module 118 employs a set of Gaussian mixture models for use in assigning objects to classes, and preferably receives inputs from a user indicating the number of models to be created and a number of observations making up each data object. The data classification module 124 may also receive inputs from the user designating the type of classifications to be performed, for example speaker identification, color classification, facial recognition or the like, as well as names for the classes. The data classification module 124 can produce appropriate descriptive labels based on these user designations.

The classifier 100 also includes, or can receive as input, from the user interface 109 or the data interface 118, training data comprising a collection of data objects, with each data object being labeled to indicate the class to which it belongs. The training data may suitably be stored on the hard disk 108 as a training data table 126. Upon receiving a designation of the number of classes and the number of mixture components required for modeling the training data, suitably received from the user or provided in accompaniment with the training data, a training module 128 creates an appropriate number of models, as indicated by the number of classes. Each model is preferably a Gaussian mixture model and is designed employ the designated number of mixture components in order to process data objects.

Once the models are created, the training module 128 uses the training data table 120 to optimize parameters for the models. First, the training data is used to estimate initial parameters c, Σ and μ for all models, where for each model, c is an I-dimensional vector of mixing parameters, that is, the relative weightings of the mixture components of the model, μ is a set of “I” mean vectors, with each vector μ being the mean vector of each mixture component of the model and Σ is a set of “I” covariance matrices showing the distribution of each set of mixture components about each mean. The estimation is preferably performed by maximum likelihood estimation, but may be performed in any of a number of alternative ways, suitably chosen to provide a reasonable value in a relatively short time. The training module 128 then selects the first model of the set. The performance of the model is tested using training data and the results stored. The values ω_{m,i} and \overline{ω}_{j,i} are computed for each mixture component “i” of the model, preferably by using equations (8) and (9) above. The weighting parameter L is determined using equation (13) and the requirement that the value of L must satisfy the requirement that D(L)>0 and 0<L≦1. The values of Σₘᵢ, μₘᵢ and cₘᵢ are then computed for every mixture component i. The computation is performed using equations (12) and (13) for Σₘᵢ, equation (15) for μₘᵢ and equations (18) and (17) for cₘᵢ. The performance of the model is evaluated using the newly computed values of Σₘᵢ, μₘᵢ and cₘᵢ and the results compared against the previously computed results. That is, the newly computed values of Σₘᵢ, μₘᵢ and cₘᵢ are used in equation (3) above to compute a value for J and the newly computed value for J is compared against the previously computed value of J. If the newly computed value of J is greater than the previously computed value, the performance of the model has improved and the newly computed values are retained for use with the model. In any case, the performance of the model using the newly computed values is stored.

If the performance of the model using the newly computed values has not improved, the model is not updated with the newly computed parameters. However, whether or not the performance of the model has improved, a new computation of the parameters is performed using the newly computed parameters as initial estimates. This process proceeds through a predetermined number of iterations. Once the parameters for the first model is optimized, the same procedure is followed for all remaining models.

Once the models have been optimized, they are passed to the classification module 124, which receives data objects as inputs, produces a label for each data object indicating the class to which the object belongs and associates the label with the corresponding data object. The classification module 124 operates by processing each data object with each model to yield a probability result indicating the probability that the data object belongs to the class associated with the model. The data object is assigned to the class whose model yields the highest result, and a label indicating the class to which the data object belongs is associated with the data object.

A classification results table 130, containing labeled data objects, may suitably be stored on the hard disk 108, copied to a compact disk using the CD-RW 120 or transmitted using the network interface 122. In addition, or alternatively, classification information may suitably be displayed employing the user interface 109. Employing the user interface 109 to display classified information may be particularly suitable for cases in which immediate action is to be taken by a human user. An example of such a case may be a situation in which facial feature information is classified to identify individuals, in order to determine whether the identified individual is on a list of authorized persons having access to a site, and to instruct a guard to permit or deny access, seek further confirmation of identity, or the like.

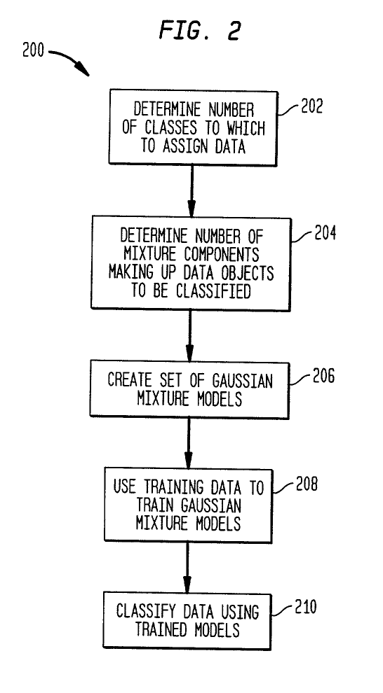

FIG. 2 illustrates a process 200 of classification of data objects according to an aspect of the present invention. The process 200 may suitably be performed by a data classification system similar to the system 100 of FIG. 1, and is preferably used to classify data received as inputs by or stored on such a system.

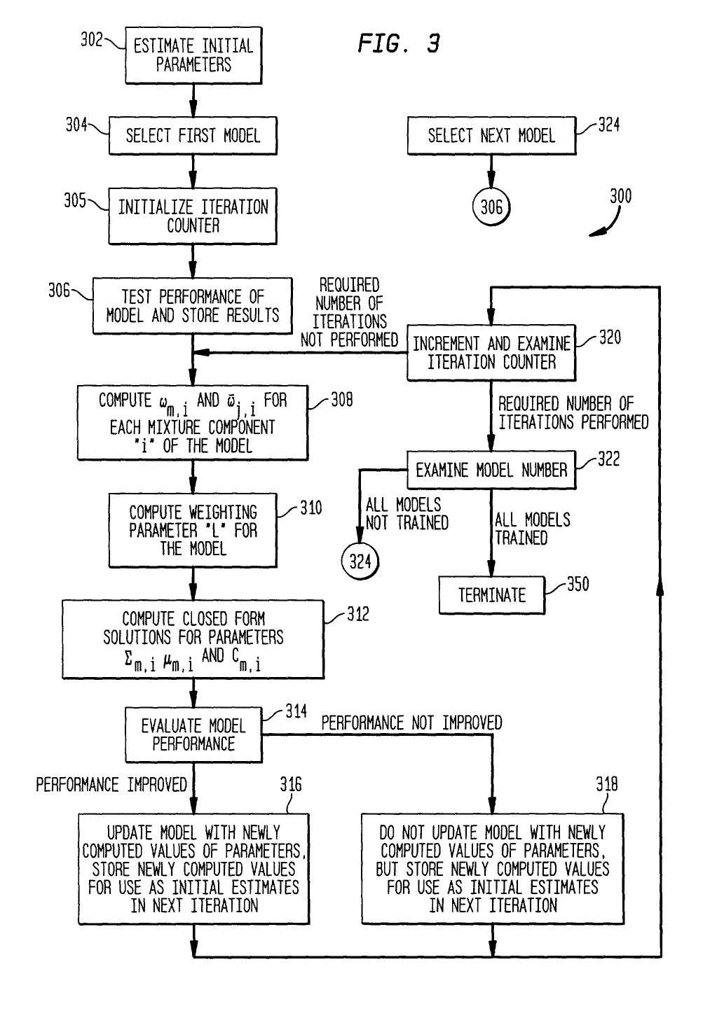

At step 202, the data to be classified is examined, and a number of classes “M” into which classifications are to be made is determined. At step 204, a number of mixture components “I” needed to characterize the data is determined. At step 206, a set of “M” Gaussian mixture models (GMM) are implemented, suitably as instructions to a computer or other data processing system, each model having the form given in equation (6) above, and each designed to use “I” mixture components to model data similar to the training data. At step 108, the models are trained to classify a set of training data whose classes are known, using an iterative process illustrated in FIG. 3 and discussed in additional detail below. The purpose of training is to optimize the parameters c_{m,i}, Σ_{m,i} and μ_{m,i} for each equation so that J, as described in equation (3) above, is maximized. Optimization is accomplished by substituting training data into closed form equations and solving the equations in order to yield values of the parameters that will maximize J. The objective in minimizing J is to minimize the error risk for the action of classification, as given in equation (2) above.

At step 210, the models are used as needed to perform classification on data objects whose classes are unknown. Data objects having generally similar characteristics to the training data and suitable for processing by the models that have been created is supplied to each model as an input. Each model yields a probability that a particular data item, or observation, belongs to the class defined by the model. The probabilities are compared, and the data object is assigned to the class whose model yields the highest probability and each data object is associated with a label indicating the class to which it belongs.

FIG. 3 illustrates a process 300 for training a set of GMM models according to the present invention. At step 302, initial parameters c, Σ and μ are estimated for all models. Estimation is preferably performed by maximum likelihood estimation, but may be performed in any of a number of alternative ways, suitably chosen to provide a reasonable value in a relatively short time. At step 304, the first model of the set is selected. At step 305, an iteration counter is initialized. At step 306, the performance of the model is tested using training data and the results stored. At step 308, the values ω_{m,i} and \overline{ω}_{j,i} are computed for each mixture component “i” of the model, preferably by using equations (8) and (9) above. At step 310, the weighting parameter L is computed using equation (13) and the requirement that the value of L must satisfy the requirement that D(L)>0 and 0<L≦1. At step 312, the values of Σₘᵢ, μₘᵢ and cₘᵢ are computed for every mixture component i. The computation is performed using equations (12) and (13) for Σₘᵢ, equation (15) for μₘᵢ and equations (18) and (17) for cₘᵢ. At step 214, the performance of the model is evaluated using the newly computed values of Σₘᵢ, μₘᵢ and cₘᵢ and the results compared against the previously computed results. That is, the newly computed values of Σₘᵢ, μₘᵢ and cₘᵢ are used in equation (3) above to compute a value for J and the newly computed value for J is compared against the previously computed value of J. If the newly computed value of J is greater than the previously computed value, the performance of the model has improved.

If the performance of the model is improved as a result of using the newly computed values for Σₘᵢ, μₘᵢ and cₘᵢ, the process proceeds to step 316, the model is updated with the newly computed values and the result using the newly computed values is stored, replacing the previously computed result. The newly computed values are also stored for use as initial estimates in the next iteration. The process then proceeds to step 320. If the performance of the model using the newly computed values has not improved, the process proceeds to step 318 and the model is not updated with the newly computed values for Σₘᵢ, μₘᵢ and cₘᵢ, but the newly computed values are stored for use as initial estimates in the next iteration. The process then proceeds to step 320.

At step 320, the iteration counter is incremented and examined to determine if the required number if iterations has been performed. If the required number of iterations has not been performed, the process returns to step 308. If the required number of iterations has been performed, the process proceeds to step 322 and the model number is examined to determine if all models have been trained. If all models have not been trained, the process proceeds to step 224, the next model is selected and the process returns to step 306. If all models have been trained, the process terminates at step 350.

The evaluation of the model performance over a number of iterations is done in order to meet the sufficient condition for optimization, which is that

$${∇}_{{θ}_{m , i}}^{2} J < 0 ,$$

and also to provide a solution for optimization in cases in which ω_{m,i} and \overline{ω}_{j,i} are not constants.

A classification system according to the present invention is useful for numerous applications, for example speaker identification. A speaker identification system receives data objects in the form of speech signals, and performs classification by identifying the speaker.

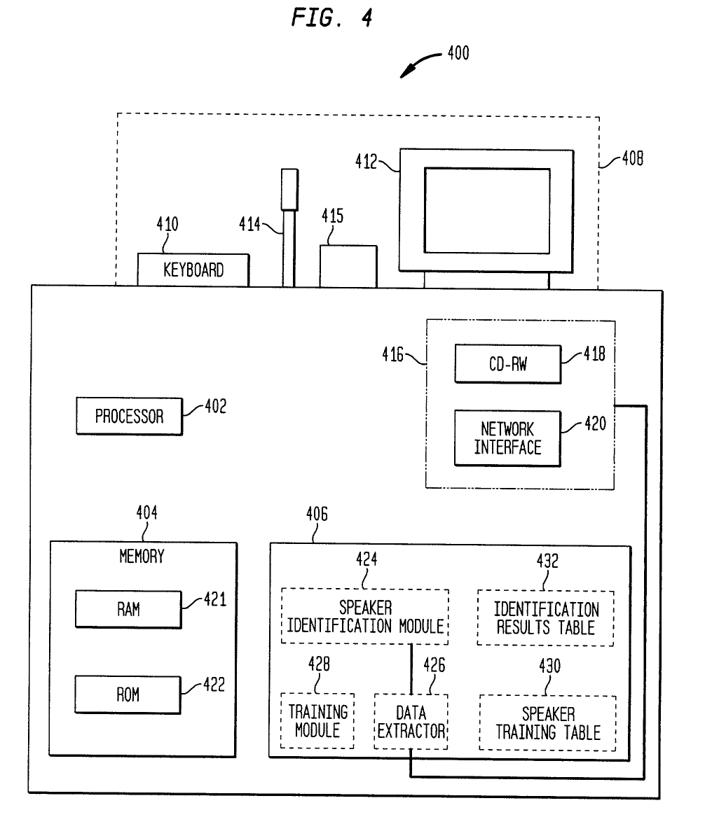

FIG. 4 illustrates a speaker identification system 400 employing techniques according to the present invention. The system 400 is similar to the system 100 of FIG. 1, and may w suitably be implemented using a personal computer and may include a processor 402, memory 404, hard disk 406 and user interface 408 including a keyboard 410 and monitor 412, as well as a microphone 414 for receiving speech inputs for recording or classification and a loudspeaker 415 for playing back speech inputs and stored speech signals. The system 400 may also include a data interface 416 for exchange of large amounts of data, such as a CD-RW 418 and network interface 420. The memory 404 preferably includes RAM 421 for storage of applications and data for processing, and ROM 422 for long-term storage of instructions.

The system 400 hosts a speaker classification module 424 for receiving data objects in the form of sets of distinguishing characteristics extracted from speech signals, analyzing the data objects and classifying the data objects by associating each data object with a label identifying the speaker. Each data object is produced by receiving a speech sample, for example by receiving speech from the microphone 414 and recording it to the hard disk or by receiving already recorded speech, for example through the CD-RW 418 or network interface 420. The speech sample is then processed by using a data extractor 426 to extract a set of characteristics of the sample in order to form the data object. The speaker classification module 424 then classifies the data object by identifying the speaker producing the speech that yielded the data object.

The speaker classification module 424 is similar to the classification module 124 of FIG. 1, and implements one model for each speaker from whom speech is expected to be received, each model being adapted to the number of mixture objects regarded as significant in a speech sample. The speaker classification module 424 is trained using a training module 428, which employs a speaker training table 430 containing a set of data objects, which in this case are created by extracting data from speech samples. Each data object is associated with a speaker identification label identifying the speaker. The training module 428 uses the speaker identification label as the class to which the data object extracted from the speech sample belongs. The training module 428 operates in a similar fashion to the training module 128 of FIG. 1, and uses the training data to optimize means, covariances matrices and mixing parameters for each model used by the speaker classification module, using an iterative process similar to that described above in FIGS. 1 and 2. Once the models implemented by the speaker classification module 424 have been optimized, the speaker classification module 424 is used to classify the identify the speakers of speech samples where the identity of the individual speaker is not know, for example by receiving, processing and identifying live speech using the microphone 414 or receiving, processing and identifying a recording of speech received using the CD-RW 418 or the network interface 420, providing the identification information to a user by means of the user interface 408, or recording the identification information in an identification results table 432 where it may then retained locally or transferred to an external device using the data interface 416.

Many other systems can be envisioned, for example a system to classify sound components, with the classes to be modeled being the identities of sound components and the data objects being sets of features relevant to the task of distinguishing sound components from one another. It will also be recognized, that a classification system such as the system 400 may be designed to be very flexible and may be able to perform classifications of different categories of data objects. For example, the same classification system may have three classification modules, one performing face identification, one performing speaker identification and one performing sound component identification, with each classification module being trained using an appropriate set of training data.

FIG. 4 is a set of graphs 502-506 illustrating experimental results for a process of classifier training such as the process 300 of FIG. 3. The goal was to train a classifier to identify English vowels. An auditory feature extraction algorithm was used to convert a speech signal to a 39-dimensional feature vector for classification. That is, each data object was to be classified using a set of 39 observations of sound characteristics of the object. The features for classification were generated from a telephone speech database. The speech was first sampled at an 8 kHz sampling rate and then a fast Fourier transform (FFT) was applied to the speech data over a 30 millisecond window shifted every 10 milliseconds through the recorded speech. Each FFT spectrum was processed by an auditory based algorithm, then converted to 12 cepstral coefficients through a discrete cosine transform. The average speech energy of the 30 millisecond window was also included as one of the observations in the feature vector. These 13-dimensional feature vectors were further augmented by a set of 13 feature coefficients of the first derivative calculated over a 5-frame window, plus another set of 13 coefficients of the second derivative calculated over a 9-frame window. Thus, every 10 milliseconds of speech presented an object comprising a 39 dimensional feature vector for identification. The frames corresponding to each vowel were partitioned into two datasets for training and testing. Depending on availability, approximately 800 objects were available for training for recognition of each vowel and approximately 100 objects were available for testing for correct identification of each vowel.

One GMM with 8 mixtures and diagonal covariance matrices was created to represent each vowel. The GMM's were first initialized by maximum likelihood estimation, and then each model was trained over four iterations using data belonging to the class for which the model was created. Next, the GMM's were further trained using k iterations of computing closed form solutions for the model parameters and testing the performance of the model. The model parameters corresponding to the best accuracy on the training dataset were saved and used as the parameters of each model.

The graph 502 illustrates the ideal performance, provided by the aggregate a posteriori equation (3), translated to an approximate accuracy. The accuracy is expressed in terms of the number of tokens correctly recognized, and plotted against the number of iterations performed. The curve 508 shows the relationship between approximate accuracy and number of iterations.

The graph 504 illustrates the performance of the models on the set of training data, expressed as approximate accuracy plotted against number of iterations performed. The curve 510 shows the relationship between accuracy and number of iterations.

The graph 506 illustrates the performance of the models on the set of testing data, expressed as approximate accuracy plotted against number of iterations performed. The curve 512 shows that the models achieved an average recognition accuracy of 74.40% on ten vowels after only two iterations.

While the present invention is disclosed in the context of a presently preferred embodiment, it will be recognized that a wide variety of implementations may be employed by persons of ordinary skill in the art consistent with the above discussion and the claims which follow below.

We claim:

1. A data object classification system, comprising:
a classification module for receiving data objects, each data object comprising a set of observations and identifying a class to which each data object belongs, the classification module using a set of models to process the data objects, each model representing one class to which a data object may belong; and
a training module for optimizing parameters to be used in the models employed by the classification module, the training module receiving a set of training data as an input and processing the training data to create initial estimates of the parameters for the models, the training module being further operative to update the parameters by computing closed form solutions for the parameters, the closed form solutions for each model being chosen to maximize the aggregate a posteriori probability that the model will correctly assign a data object to the class associated with the model.

2. The system of claim 1, wherein the models are Gaussian mixture models.

3. The system of claim 2, wherein the initial estimates are created using maximum likelihood estimation.

4. The system of claim 3, wherein the training module is further operative to test the performance of the updated parameters for each model by using the model to classify the training data and evaluate the performance of the model in accurately classifying the training data, and to update the model with the updated parameters if the performance of the model is improved.

5. The system of claim 4, wherein the training module is operative to perform a predetermined number of iterations comprising the computing of new solutions for the parameters of each model, each iteration including the testing of the model performance using the new parameters, the saving of the new parameters for use in the next iteration and the updating of the model with the new parameters if the performance of the model has improved and the use of the new parameters as initial parameters in the next iteration.

6. The system of claim 5, wherein the parameters are the mean, covariance matrix and probability density values for the mixture components of each model.

7. A process of classifier training for training the classifier to correctly identify each class of a plurality of classes to which each data object in a set of training data belongs, each data object comprising a set of observations providing representations of characteristics of the object useful for classifying the object, comprising the steps of:
receiving and analyzing a set of training data comprising a set of data objects, each data object in the training data comprising set of observations and a label identifying the class to which the data object belongs
implementing a set of models, each model to be optimized to correctly classify the set of training data, one model representing each of the plurality of classes;
simultaneously estimating initial parameters for all models for the parameters to be optimized;
for each model, computing closed form solutions for the parameters to be optimized, the solutions being computed in order to maximize the aggregate a posteriori probability that the model will correctly assign a data object to the class associated with the model.

8. The method of claim 7, wherein the process of computing closed form solutions for the parameters comprises performing a series of iterations for each model comprising testing the performance of the model using newly computed parameters, saving the newly computed parameters for use in the next iteration, updating the model with the newly computed parameters if the performance of the model is improved, retaining the previous parameters for use in the model if the newly computed parameters do not improve the performance of the model, and using the newly computed parameters in the next iteration.

9. The method of claim 8, wherein the step of estimating initial values for the models comprises performing maximum likelihood estimation.

10. The method of claim 9, wherein the models are Gaussian mixture models.

11. The method of claim 10, wherein the parameters for which closed form solutions are computed are the mean, covariance matrix and mixing parameters for the mixture components of each model.

12. A speaker identification system, comprising:
a data extractor for receiving speech signals and extracting identifying characteristics of the speech signals to create data objects comprising characteristics of the speech signals useful for identifying a speaker producing the speech;
a speaker identification module for receiving one or more data objects and identifying the speaker producing the speech signal associated with the data object, the speaker identification module implementing a set of models to process the speech signals, each model being associated with a possible speaker; and
a training module for optimizing parameters to be used in the models implemented by the speaker identification module, the training module receiving a set of training data as an input and processing the training data to create initial estimates of the parameters for the models, the training module being further operative to update the parameters by computing closed form solutions for the parameters, the closed form solutions for each model being chosen to maximize the aggregate a posteriori probability that the model will correctly associate a data object with the speaker producing the speech signal from which the data object was created.

13. The system of claim 12, wherein the models are Gaussian mixture models.

14. The system of claim 3, wherein the initial estimates are created using maximum likelihood estimation.

15. The system of claim 14, wherein the training module is further operative to test the performance of the updated parameters for each model by using the model to classify the training data and to evaluate the performance of the model in accurately classifying the training data, and to update the model with the updated parameters if the performance of the model is improved.

16. The system of claim 15, wherein the training module is operative to perform a predetermined number of iterations comprising the computing of new solutions for the parameters of each model, each iteration including the testing of the model performance using the new parameters, the saving of the new parameters for use in the next iteration, the updating of the model with the new parameters if the performance of the model has improved and the use of the new parameters as initial parameters in the next iteration.

17. The system of claim 16, wherein the parameters are the mean, covariance matrix and probability density values for the mixture components of each model.
